(19) United States
(12) Patent Application Publication
(10) Pub. No.: US 2006/0164830 A1
(43) Pub. Date: Jul. 27, 2006

(54) Colour tunable lighting element

(76) Inventor: Thomas Justel, JPHILIPS INTELLECTUAL PROPERTY (DE)

Correspondence Address: PHILIPS INTELLECTUAL PROPERTY & STANDARDS, P.O. BOX 3001, BRIARCLIFF MANOR, NY, 10510, US

(21) Appl. No.: 10/564,543

(22) PCT Filed: Jul. 7, 2004
(86) PCT No.: PCT/IB04/51153

§ 371 Date: Jan. 12, 2006

(30) Foreign Application Priority Data
Jul. 15, 2003 (EP) 0102163.7

(51) Int. Cl. F21V 9/00

(52) U.S. Cl. 362/231; 362/293; 362/295; 362/613; 362/240

(57) ABSTRACT

A colour tunable lighting element is described, which comprises an assembly of dielectric barrier discharge lamps, each of them filled with a noble gas or a noble gas mixture, wherein a Hg low-pressure discharge generates invisible UV radiation, which is converted into visible light by one or several phosphors being coated onto the inner surface of the bulb, wherein the visible light of several dielectric barrier discharge lamps is mixed by optical means and is emitted homogeneously. Such an assembly of dielectric barrier discharge lamps is useful for the generation of white light with an arbitrary colour temperature and of saturated coloured light.

The present application relates to a colour tuning lighting element comprising an assembly of dielectric barrier discharge lamps, in which invisible UV-radiation is converted into visible light by one or several phosphors coated onto the inner surface of the bulb.

Lighting elements, which emit a diffuse, plane light, are nowadays widely used. These developments are directed to an increase of the variability of colours. By the use of several coloured lamps in one housing, the light of such lamps can be mixed by optical means and by modifying the portions of the used colours allows to change the colour points of the light, which is emitted from the lighting element. This effect can be realized with different types of lamps, but they still have a number of disadvantages, which will be overcome by the present invention.

The essential disadvantage of the known lighting system consists in the fact, that due to the content of portions of the visible Hg-spectrum, coloured lamps do not emit a saturated colour, which limits the obtainable range of colours. Moreover, such lamps are dimmable only to a certain degree, which is a disadvantage for their use.

If the lamps are replaced by LEDs, it is possible to obtain saturated primary colours. However, due to the low half-width of the emission bands of the LEDs, many different LEDs (red, green, blue, orange-yellow, turquoise) have to be used for the reproduction of the complete CIE colour triangle. Moreover, the light yields of the presently available LEDs are still low, which implies that a considerable number of LEDs has to be employed in order to reach a sufficient lightness. This increases the costs for a system based on LEDs.

Electric light bulbs used together with colour filters are, however, so inefficient, that a high loss of power is observed, combined with corresponding problems of heat removal.

Therefore, a demand exists for systems with the following properties: high colour saturation; small design; complete dimmability; sufficient lifetime; good efficiency; competitive price per lumen

No system is presently available, which satisfies such conditions completely.

The present invention is based on the use of noble gas containing dielectric barrier discharge lamps for luminaries or light-tiles with variable light colours. Thereby, use is made of the many advantages of noble gas dielectric barrier discharge lamps:

Subject of the invention is a colour tuneable lighting element comprising an assembly of dielectric barrier discharge lamps, each of them filled with a noble gas or a noble gas mixture, wherein a Hg low-pressure discharge generates invisible UV radiation, which is converted into visible light by one or several phosphors being coated onto the inner surface of the bulb and wherein the visible light of several dielectric barrier discharge lamps is mixed by optical means and is emitted homogenously.

Especially preferred for the lighting element according to the invention is a noble gas mixture containing Xenon and Neon. Such a lighting element emits nearly exclusively UV-light, which is converted by the phosphors in visible light.

If pure Xenon (Xe₂*-Excimer-discharge) is used then UV-light with a wavelength at 172 and 150 nm is emitted, which means that the plasma is virtually invisible. The admixture of Neon is advantageous, because it allows a reduction of the lighting voltage of the discharge lamps from 2 kV up to 200V depending on the content of Neon (Penning-Effect). This allows the use of electronic driver units which are presently commercially available for Neon discharge lamps. However, the Xenon portion must be at least 10%, as otherwise also resonance lines of Neon between 580 and 700 nm are emitted. This would reduce the clarity of the colours of blue, green or red lamps considerably. Only for such lamps, which anyway emit in the red range of the spectrum, high Neon concentrations can be used.

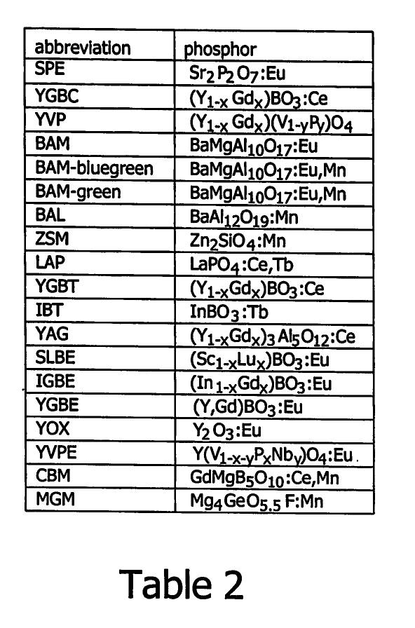

Depending on the nature of the used phosphor the lamps emit coloured light which is determined only by the emission of the phosphor, because the spectrum of the Xe excimer plasma contains no visible light. Consequently, in selecting a suitable phosphor (see FIG. 8), a very high colour saturation can be obtained. Phosphors, which efficiently convert the radiation of a Xenon or Xenon/Neon-discharge (147, 150, 172 nm) invisible light are listed in table 1.

TABLE 1
Phosphors and the energy efficiency as well as the colour points of the
coloured Xenon-dielectric discharge lamps (fill pressure 200 mbar
Xe, driver frequency: 20 kHz

| | | | | Colour point |
|---|---|---|---|---|
| Emission- | | Emission | Energy efficiency of the | x, y of the Xe- |
| Colour | Phosphor | at [nm] | Xe-discharge lamp* | discharge lamp* |
| Blue | Sr₂P₂O₇:Eu | 422 | 5% | 0.167, 0.014 |
| | (Y₁₋ₓGdₓ)BO₃:Ce | 420 | 5% | 0.178, 0.159 |
| | Y₁₋ₓGdₓ)(V_{1-y}P_{y})O₄ | 420 | 5% | 0.164, 0.143 |
| | BaMgAl₁₀O₁₇:Eu | 453 | 16% | 0.148, 0.069 |
| blue-green | BaMgAl₁₀O₁₇:Eu,Mn | 453, 515 | 12% | 0.146, 0.195 |
| Green | BaMgAl₁₀O₁₇:Eu,Mn | 515 | 11% | 0.126, 0.650 |
| | BaAl₁₂O₁₉:Mn | 518 | 8% | 0.204, 0.717 |
| | Zn₂SiO₄:Mn | 525 | 5% | 0.226, 0.709 |
| | LaPO₄:Ce,Tb | 543 | 11% | 0.352, 0.580 |
| | (Y₁₋ₓGdₓ)BO₃:Tb | 544 | 10% | 0.338, 0.615 |
| | InBO₃:Tb | 544 | 5% | 0.331, 0.621 |
| Yellow | (Y₁₋ₓGdₓ)₃Al₅O₁₂:Ce | 570 | 9% | 0.451, 0.532 |
| Orange | (Sc₁₋ₓLuₓ)BO₃:Eu | 590 | 6% | 0.608, 0.384 |
| | (In₁₋ₓGdₓ)BO₃:Eu | 590 | 7% | 0.609, 0.385 |
| Red | (Y,Gd)BO₃:Eu | 595 | 7% | 0.638, 0.354 |
| | Y₂O₃:Eu | 611 | 5% | 0.650, 0.349 |
| | Y(V_{1-x-y}PₓNb_{y})O₄:Eu | 622 | 6% | 0.662, 0.326 |
| | GdMgB₅O₁₀:Ce,Mn | 630 | 5% | 0.662, 0.334 |
| | Mg₄GeO_{5,5}F:Mn | 656 | 5% | 0.700, 0.287 |

A preferred object of the invention is therefore a colour tuneable lighting element comprising an assembly of several electric barrier discharge lamps emitting red, green or blue light, wherein said lamps are equipped with one or several phosphors selected from the following groups:
2.1 red: (Y,Gd)BO₃:Eu, Y₂O₃:Eu, Y(V_{1-x-y}PₓNb_{y})O₄:Eu, GdMgB₅O₁₀:Ce,Mn, Mg₄GeO_{5.5}F:Mn
2.2 green: BaMgAl₁₀O₁₇:Eu,Mn, BaAl₁₂O₁₉:Mn,Zn₂SiO₄:Mn, LaPO₄:Ce,Th, (Y₁₋ₓGdₓ)BO₃:Tb, InBO₃:Tb
2.3 blue: Sr₂P₂O₇:Eu, BaMgAl₁₀O₁₇:Eu, (Y₁₋ₓGdₓ)BO₃:Ce, (Y₁₋ₓGdₓ)(V_{1-y}P_{y})O₄

A further preferred tuneable lighting element comprises an assembly of several dielectric barrier discharge lamps emitting blue or yellow light, wherein said lamps are equipped with one or several phosphors selected from the following groups:
3.1 blue: BaMgAl₁₀O₁₇:Eu, (Y₁₋ₓGdₓ)BO₃:Ce, (Y₁₋ₓGdₓ)(V_{1-y}P_{y})O₄
3.2 yellow: (Y₁₋ₓGdₓ)₃Al₅O₁₂:Ce, (Y₁₋ₓGdₓ)₃(Al_{1-y}Ga_{y})₅O₁₂:Ce

A further preferred object of the invention is a colour tuneable lighting element comprising an assembly of several dielectric barrier discharge lamps emitting blue-green or orange light, wherein said lamps are equipped with one or several phosphors selected from the following groups:
4.1 blue-green: BaMSAl₁₀O₁₇:Eu,Mn
4.2 orange: (Sc₁₋ₓLuₓ)BO₃:Eu, (In₁₋ₓGdₓ)BO₃:Eu

It is obvious, that the lighting element of the invention due to their energy efficiency between 5 and 15% are significantly more efficient than electric light bulbs with coloured filters. As the discharge of the lamps takes place at a very short distance the form of the lamps can be designed very variably. They may have the form of a thin tube, but may also have a plane shaping with a large surface. These properties render the electric varied discharge lamps very suitable for colour tuneable lighting elements.

It is a further advantage of the lighting elements of the invention, that the lightness of each single dielectric barrier discharge lamp may be varied independently, which allows to adjust the emission colour of the lighting element individually as required. Moreover by use of suitable optical filter means, the resulting colour of the emitted light may be adjusted to yield a white light.

The invention is further illustrated by the attached figures.

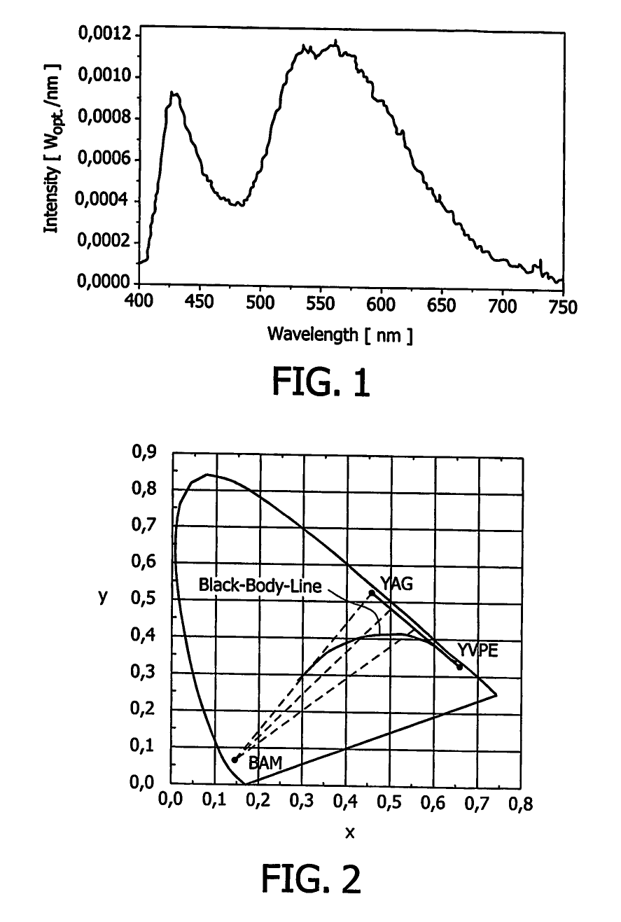

FIG. 1 shows the spectrum of a light tile, containing Xenon-dielectric barrier discharge lamps with BaMgAl₁₀O₁₇:Eu and (Y₁₋ₓGdₓ)₃Al₅O₁₂:Ce as phosphors.

FIG. 2 shows a colour triangle with adjustable colour points of a light tile with Xenon-dielectric barrier discharge lamps.

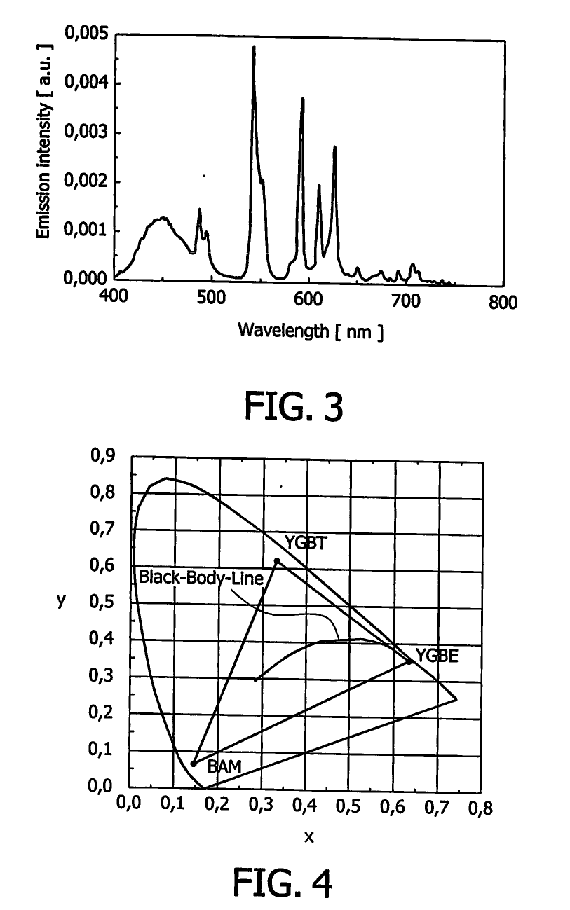

FIG. 3 shows the spectrum of a light tile contain Xenon-dielectric barrier discharge lamps with BaMgAl₁₀O₁₇Eu, (Y,Gd)BO₃:Tb and (Y,Gd)BO₃:Eu as phosphors.

FIG. 4 shows a colour triangle with adjustable colour points of a light tile with Xenon-dielectric barrier discharge lamps, which are coated either with BaMgAl₁₀O₁₇Eu (BAM), (Y,Gd)BO₃:Tb (YGBT) or (Y,Gd)BO₃:Eu (YGBE).

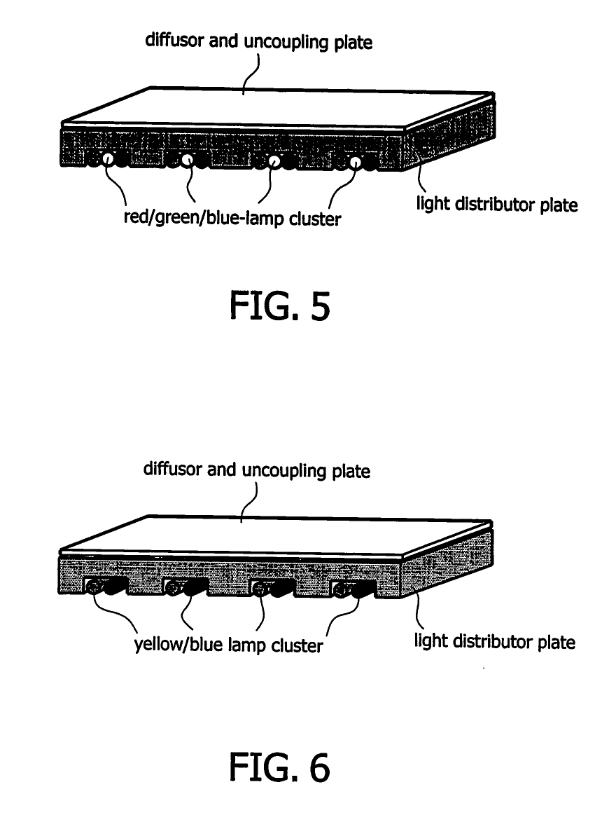

FIG. 5 shows a light tile with a “channel-lit backlight”, which contains several clusters each consisting of a red, green and blue-emitting Xenon-dielectric barrier-discharge lamp.

FIG. 6 shows a light tile with a “channel-lit backlight”, containing several clusters, each with a yellow and blue emitting Xenon-dielectric barrier discharge lamp.

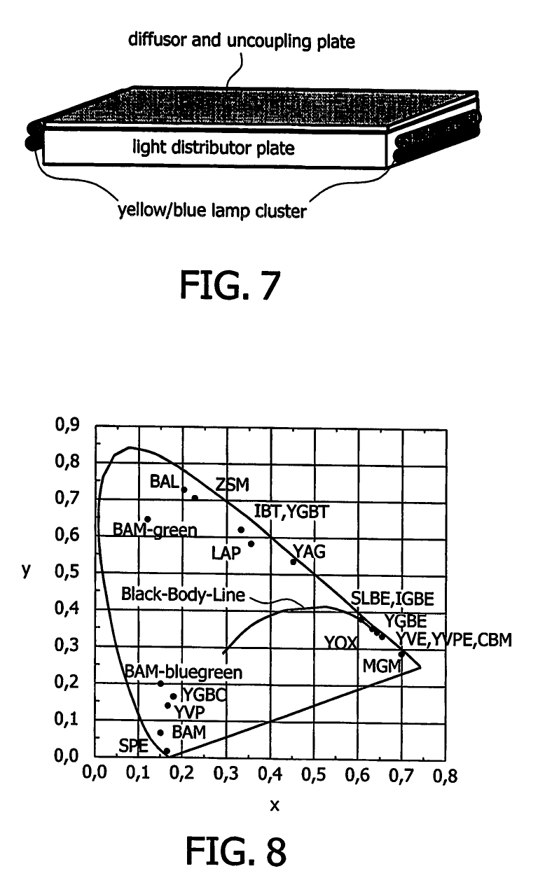

FIG. 7 shows a light tile with a “side-lit backlight”, containing several clusters, each with yellow and blue-emitting Xenon-dielectric barrier discharge lamp.

FIG. 8 shows the colour points of Xenon-dielectric barrier discharge lamps for use as primary light sources in the light tiles of FIG. 6 to 8.

Table 2 shows a list of abbreviations of the phosphors, which are used in FIG. 8.

### EXAMPLE 1

Light Tiles with Blue and Yellow Emitting Xenon-Dielectric Barrier Discharge Lamps

A cavity-lit light tile as shown in FIG. 6 has been equipped with an assembly of blue and yellow light emitting dielectric barrier discharge lamps. The blue lamps have been coated with BaMgAl₁₀O₁₇:Eu (BAM) and the yellow lamps with (Y₁₋ₓGdₓ)₃Al₅O₁₂:Ce (YAG) as phosphors by a conventional Up-Flush-Coating-Process. The spectrum of such a light tile is shown in FIG. 1.

Each lamp of such light tile can be controlled by a separate driver with the effect, that the lightness of the lamps may be separately adjusted. Thus it is possible to tune each colour point, which is located on the line defined by the colour coordinates of the two coloured dielectric barrier discharge lamps (see FIG. 2).

The colour point of the adjustment shown in FIG. 1 is at x=0,346 and y=0,400, i.e. the colour temperature is at about 5100 K. At this adjustment the colour rendering is at Rₐ=70.

With the assembly of this example all colour points may be tuned by dimming which are located on the line between the colour points of the BAM-lamps and the YAG-lamps of FIG. 2.

The light colour of the light tiles may be influenced by the dimming of the Xenon dielectric barrier discharge lamps, whereby, however only such light colours can be reproduced, which are within the colour gamut defined by the primary colours of the different coloured lamps.

Light tiles, which also allow the adjustment of lower colour temperatures, may be realized if the yellow lamps are modified. For such a purpose the yellow lamps are coated with a phosphor mixture consisting of (Y₁₋ₓGdₓ)₃Al₅O₁₂:Ce (YAG) and YVO₄:Eu (YVE) or Y(V_{1-x-y}PₓNb_{y})O₄:Eu (YVPE). Depending on the ratio of the mixture the colour points are located on the line, which is defined by the colour points of BAM and the YAG/YVE or YAG/YVPE mixtures.

### EXAMPLE 2

Light Tile with Red, Green and Blue-Emitting Xenon Dielectric Barrier Discharge Lamps

A cavity-lit light tile as shown in FIG. 5 was equipped with an assembly of red, green and blue emitting dielectric barrier discharge lamps. The blue lamps have been coated with BaMgAl₁₀O₁₇:Eu (BAM) as phosphor, the green with (Y,Gd)BO₃:Tb (YGBT) as phosphor and the red with (Y,Gd)BO₃:Eu (YGBE) as phosphor by the conventional Up-Flush-Coating-Process.

Each lamp was controlled by a separate driver, so that the lightness of each lamp could be adjusted separately. This permits the adjustment of each colour point being located within the colour triangle, which is defined by the colour coordinates of the respective coloured dielectric barrier discharge lamps.

FIG. 3 shows a colour point of said light tile at x=0,325 and y=0,305, i.e. the colour temperature is about 5900 K. At this adjustment the colour reproduction is at Rₐ=87. With this assembly all colour points may be tuned by dimming which are located within the triangle, which is defined by the colour points of BAM-, YGBT- and YGBE lamps as shown in FIG. 4.

FIG. 4 shows the colour triangle which is mentioned in the description of FIG. 3.

FIG. 5 shows a light tile with a “channel-lit-backlight” consisting of a light distributor plate which contained several clusters of a red, green and blue-emitting xenon-dielectric barrier discharge lamp. The light distributor plate is covered by a diffuser and uncoupling plate.

FIG. 6 shows a light tile with a “channel-lit-backlight” consisting of a light distributor plate in which several clusters, each consisting of a yellow and a blue emitting xenon-dielectric barrier discharge lamp are placed. The light distributor plate is covered by a diffuser and uncoupling plate.

FIG. 7 shows a light tile with a “side-lit-backlight” consisting of a light distributor plate with clusters of yellow and blue emitting xenon-dielectric barrier discharge lamps which are located at the opposite sites of the light distributor plate which is covered by a diffuser and uncoupling plate.

FIG. 8 shows the colour points of the xenon-dielectric barrier discharge lamps for use as primer relight sources in the tiles of FIG. 6 to 8.

1. A colour tuneable lighting element comprising an assembly of dielectric barrier discharge lamps, each of them filled with a noble gas or a noble gas mixture, wherein a Xe excimer discharge generates invisible UV radiation, which is converted into visible light by one or several phosphors being coated onto the inner surface of the bulb and wherein the visible light of several dielectric barrier discharge lamps is mixed by optical means and is emitted homogenously.

2. A colour tuneable lighting element as claimed in claim 1 comprising an assembly of several electric barrier discharge lamps emitting red, green or blue light, wherein said lamps are equipped with one or several phosphors selected from the following groups:
2.1 red: (Y,Gd)BO₃:Eu, Y₂O₃:Eu, Y(V_{1-x-y}PₓNb_{y})O₄:Eu, GdMgB₅O₁₀:Ce,Mn, Mg₄GeO_{5.5}F:Mn
2.2 green: BaMgAl₁₀O₁₇:Eu,Mn, BaAl₁₂O₁₉:Mn,Zn₂SiO₄:Mn, LaPO₄:Ce,Tb, (Y₁₋ₓGdₓ)BO₃:Tb, InBO₃:Tb
2.3 blue:Sr₂P₂O₇:Eu, BaMgAl₁₀O₁₇:Eu, (Y₁₋ₓGdₓ)BO₃:Ce, (Y₁₋ₓGdₓ) (V_{1-y}P_{y})O₄

3. A colour tuneable lighting element as claimed in claim 1 comprising an assembly of several dielectric barrier discharge lamps emitting blue or yellow light, wherein said lamps are equipped with one or several phosphors selected from the following groups:
3.1 blue:BaMgAl₁₀O₁₇:Eu, (Y₁₋ₓGdₓ)BO₃:Ce, (Y₁₋ₓGdₓ) (V_{1-y}P_{y})O₄
3.2 yellow: (Y₁₋ₓGdₓ)₃Al₅O₁₂:Ce, (Y₁₋ₓGdₓ)₃(Al_{1-y}Ga_{y})₅O₁₂:Ce

4. A colour tuneable lighting element as claimed in claim 1 comprising an assembly of several dielectric barrier discharge lamps emitting blue-green or orange light, wherein said lamps are equipped with one or several phosphors selected from the following groups: 4.1 blue-green: BaMgAl₁₀O₁₇:Eu,Mn
4.2 orange: (Sc₁₋ₓLuₓ)BO₃:Eu, (In₁₋ₓGdₓ)BO₃:Eu

5. A colour tuneable lighting element as claimed in claims 1, wherein the brightness of each of the lamps may be varied independently by a suitable electronic driver unit.

6. A colour tuneable lighting element as claimed in claim 1, wherein the brightness of the lamps is varied by suitable optical filter means in such a way, that the resulting colour of the emitted light is white.

7. Use of an assembly of dielectric barrier discharge lamps as claimed claim 1 for the generation of saturated colourful light.
